(19) United States
(12) Patent Application Publication
(10) Pub. No.: US 2009/0180355 A1
(43) Pub. Date: Jul. 16, 2009

(54) TIMEPIECE WITH MONITORING, MESSAGING, TRACKING, AND EMERGENCY SERVICES

(76) Inventor: Tyrone Cartwright, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/014,973

(22) Filed: Jan. 16, 2008

(51) Int. Cl. G04B 47/00

(52) U.S. Cl. 368/12; 368/10

(57) ABSTRACT

A timepiece incorporating monitoring, messaging, tracking, and/or emergency services into a watch. Specifically, (1) a biometric module can be installed into the watch for communicating any detected removal of the watch from a person wearing the watch to one or more remote terminals (e.g., a landline telephone, a cellular phone, a personal computer, a laptop and/or a personal data assistant), (2) a telecommunication module can be installed into the watch for communicating a telecommunication message (e.g., a voice message or a text message) between the watch and the remote terminal(s), (3) a global positioning system module can be installed into the watch for communicating information indicative of a location of the watch to the remote terminal(s), and/or (4) an emergency module can be installed into the watch for communicating an emergency alert signal from the watch to the remote terminal(s).

### FIELD OF THE INVENTION

The present invention generally relates to a timepiece of any type. The present invention specifically relates to a timepiece having monitoring, messaging, tracking, and/or emergency services.

### BACKGROUND OF THE INVENTION

Mobile/cellular phones are portable telecommunication devices based on a cellular network of base stations/cell sites interconnected with the public switched telephone network (“PSTN”). Furthermore, mobile/cellular phones may provide additional services such as, for example, voice mail, caller ID/history, text messaging, email, and Internet access. One consumer drawback to mobile/cellular phones is the inability of everyone to purchase and maintain a mobile/cellular phone in view of the cost of such additional services. This drawback is magnified in a case of emergency where a failure to own a mobile/cellular phone may be detrimental to a person.

### SUMMARY OF THE INVENTION

The present invention provides a new and unique timepiece incorporating monitoring, messaging, tracking and emergency services into a watch for purposes of overcoming the consumer drawback of mobile/cellular phones. For purposes of the present invention, the term “watch” is broadly defined herein as any apparatus or device for measuring, recording and displaying the progress of time, and intended to be worn by a person.

In a first form of the present invention, the timepiece has a biometric module installed into the watch, wherein the biometric module is operable to communicate any detected removal of the watch from a person wearing the watch to one or more remote terminals (e.g., a landline telephone, a mobile/cellular telephone, a personal computer, a laptop, and a personal data assistant).

In a second form of the present invention, the timepiece has a telecommunication module installed into the watch, wherein the telecommunication module is operable to communicate a telecommunication message (e.g., a voice message or a text message) between the watch and the remote terminal(s).

In a third form of the present invention, a timepiece has a global positioning system (“GPS”) module installed into the watch, wherein the GPS module is operable to communicate information indicative of a location of the watch to the remote terminal(s).

In a fourth form of the present invention, a timepiece has an emergency module installed into the watch, wherein the emergency module is operable to communicate an emergency alert signal from the watch to the remote terminal(s).

The aforementioned forms and other forms as well as objects and advantages of the present invention will become further apparent from the following detailed description of various embodiments of the present invention read in conjunction with the accompanying drawings. The detailed description and drawings of the various embodiments of the present invention are merely illustrative of the present invention rather than limiting, the scope of the present invention being defined by the appended claims and equivalents thereof.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 illustrates a block diagram of an exemplary embodiment of a timepiece in accordance with the present invention;

FIG. 2 illustrates a flowchart representative of an exemplary embodiment of a biometric monitoring method in accordance with the present invention;

FIG. 3 illustrates a flowchart representative of an exemplary embodiment of a telecommunication messaging method in accordance with the present invention;

FIG. 4 illustrates a flowchart representative of an exemplary embodiment of a GPS/GEO tracking method in accordance with the present invention;

FIG. 5 illustrates a flowchart representative of an exemplary embodiment of an emergency notification method in accordance with the present invention; and

FIG. 6 illustrates a front view of an exemplary embodiment of a watch in accordance with the present invention.

### DETAILED DESCRIPTION OF THE INVENTION

For the purposes of promoting an understanding of the principles of the present invention, reference will now be made to various exemplary embodiments illustrated in the drawings and specific language will be used to describe the same. It will nevertheless be understood that no limitation of the scope of the present invention is thereby intended, and alterations and modifications in the illustrated devices, and further applications of the principles of the disclosure as illustrated therein are herein contemplated as would normally occur to one skilled in the art to which the disclosure relates.

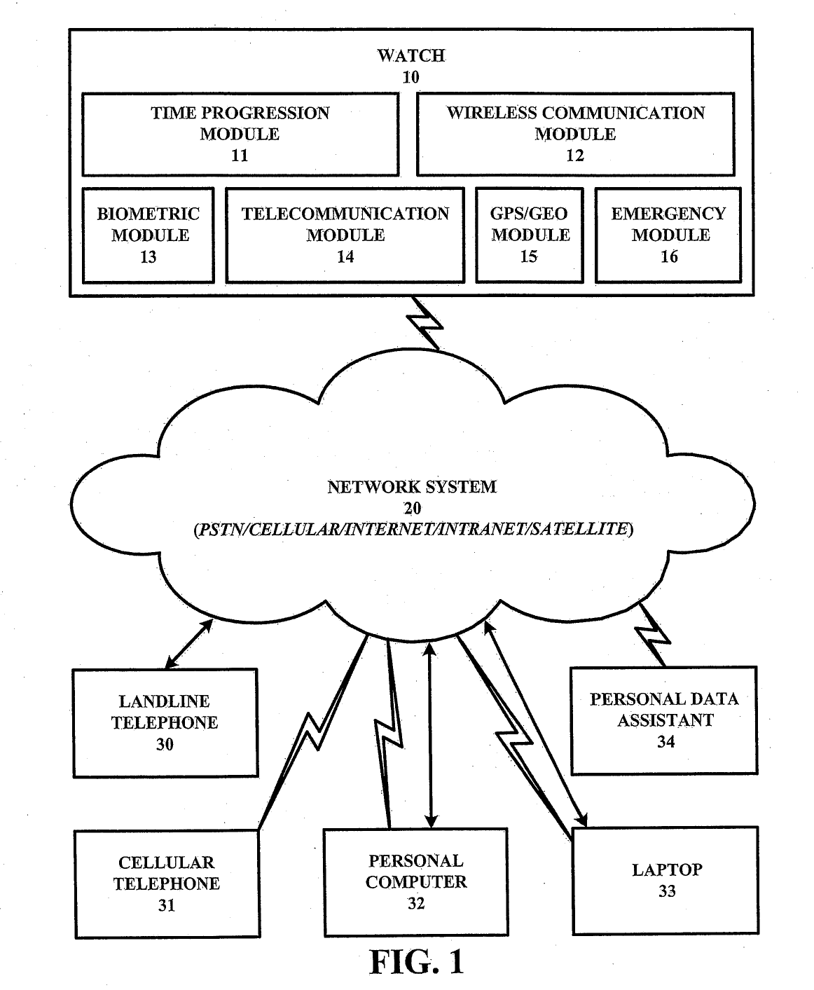

FIG. 1 illustrates a timepiece of the present invention incorporating monitoring, messaging, tracking and emergency services into a watch 10. Specifically, watch 10 employs a time progression module 11 for measuring, recording and displaying the progress of time as known in the art. Additionally and uniquely, watch 10 further employs a wireless communication module 12, a biometric module 13, a telecommunication module 14, a GPS/GEO module 15 and an emergency module 16.

Wireless communication module 12 is structurally configured for facilitating wireless communication via a network system 20 between watch 10 and various remote terminals such as, for example, a landline telephone 20, a cellular telephone 31, a personal computer 32, a laptop 33 and a personal data assistant 34. In practice, network system 20 may consist of the public switch telephone network, a cellular network, an internet, an intranet and/or a satellite network, and wireless communication module 12 may be Bluetooth™ enabled and/or WiFi enabled for facilitating wireless communication via these component(s) of network system 20 between watch 10 and the remote terminal(s) 30-34.

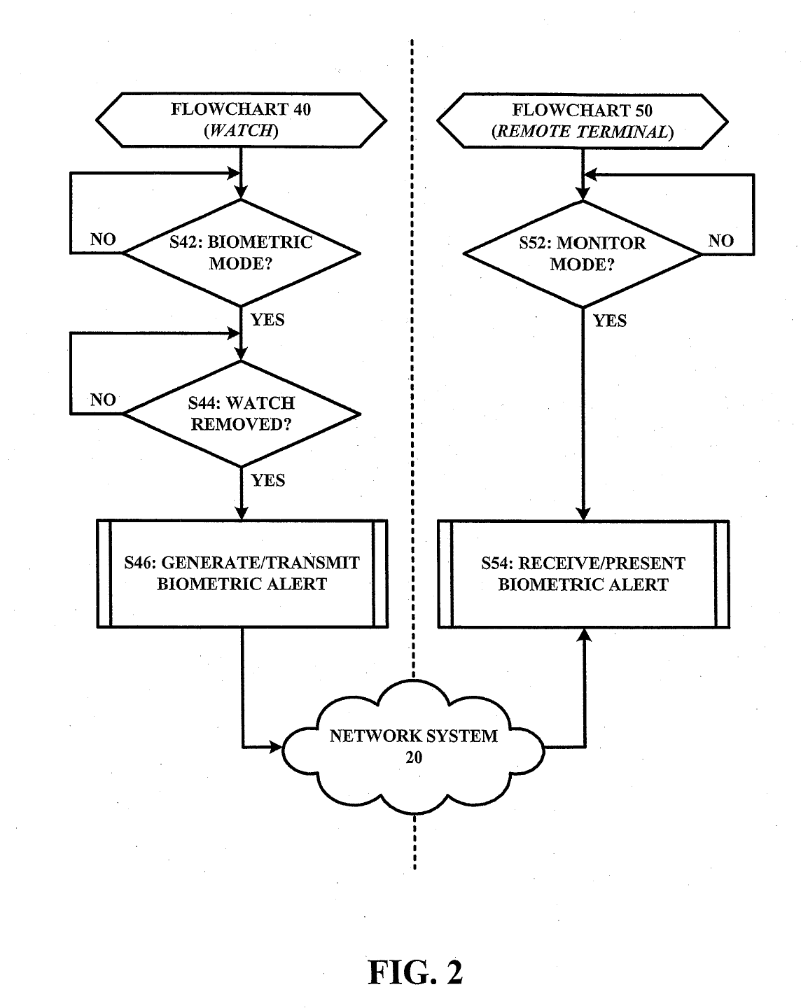

Biometric module 13 is structurally configured for communicating any detected removal of watch 10 from a person wearing watch 10 to one or more of the remote terminals 30-34. In one embodiment, biometric module 13 and the remote terminals 30-34 implement a biometric monitoring method of the present invention as represented by respective flowcharts 40 and 50 illustrated in FIG. 2.

Referring to FIG. 2, upon watch 10 being activated into a biometric mode as determined during a stage S42 of flowchart 40, biometric module 13 executes a stage S44 of flowchart 40 to detect any removal of watch 10 from a person wearing watch 10. Upon a detection of a removal of watch 10 from a person wearing watch 10, biometric module 13 proceeds to a stage S46 of flowchart 40 to generate and transmit a biometric alert indicative of the detected removal of watch 10 to one or more of the remote terminals 30-34 via network system 20. If the remote terminal(s) 30-34 is(are) activated in a monitoring mode as determined during a stage S52 of flowchart 50, then the remote terminal(s) 30-34 will receive and present (i.e., display or audible) the biometric alert during a stage S54 of flowchart 50. Stage S44 may encompass a removal time period indicative of a minimum amount of time required for watch 10 to be removed from the person before proceeding to stage S46, to thereby prevent biometric module 13 from unnecessarily generating and transmitting the biometric alert to the remote terminal(s) 30-34.

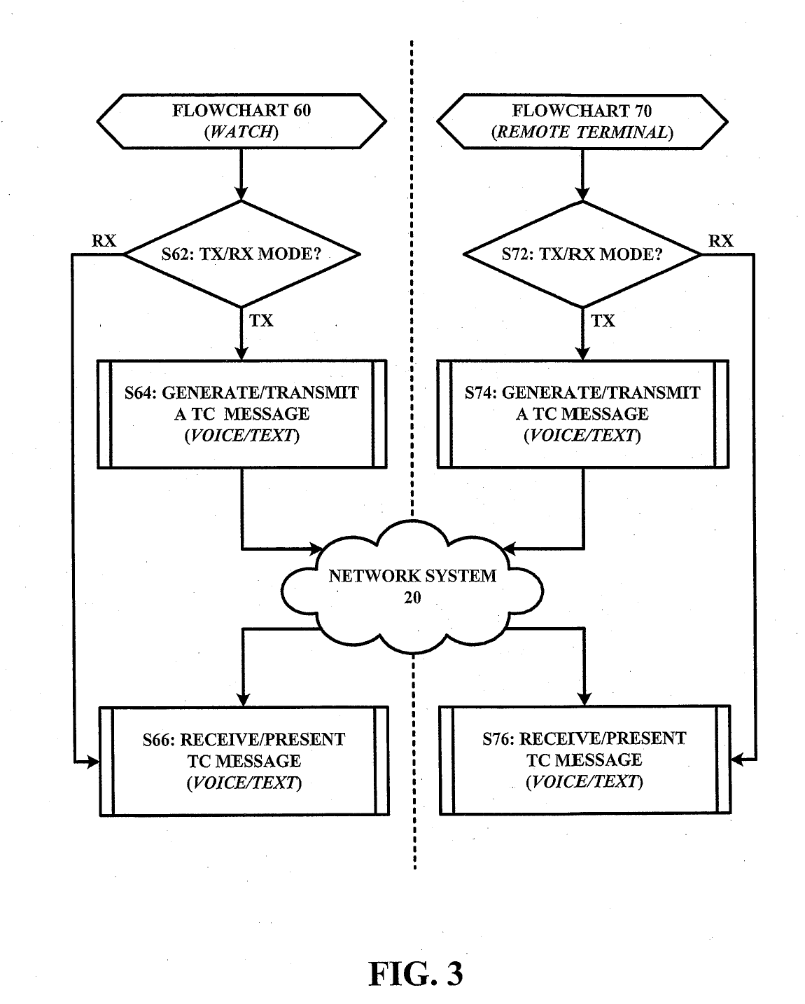

Referring again to FIG. 1, telecommunication module 14 is structurally configured for communicating a telecommunication message in the form of a voice message or a text message between watch 10 and one or more of the remote terminals 30-34. In one embodiment, telecommunication module 14 and the remote terminals 30-34 implement a telecommunication messaging method of the present invention as represented by respective, flowcharts 60 and 70 illustrated in FIG. 3.

Referring to FIG. 3, watch 10 is activated in a default reception (“RX”) mode during respective stage S62 of flowchart 60 to thereby await any communication of a telecommunication (“TC”) message (e.g., voice or text) from one of the remote terminals 30-34 during a stage S66 of flowchart 60. Similarly, one or more of the remote terminal 30-34 are activated in a default reception (“RX”) mode during respective stage S72 of flowchart 70 to thereby await any communication of a telecommunication (“TC”) message (e.g., voice or text) from watch 10 during a stage S76 of flowchart 70.

Upon being activated to a transmission (“TX”) mode by a user of watch 10 during stage S62, telecommunication module 14 proceeds to a stage S64 of flowchart 60 to generate and transmit a TC message via network system 20 to one or more of the remote terminals 30-34, which receive(s) the TC message during stage S76. Conversely, upon being activated to TX mode by a user of a particular remote terminal 30-34 during stage S72, such remote terminal 30-34 proceeds to a stage S74 of flowchart 70 to generate and transmit a TC message via network system 2 to watch 110 which receives the TC message during stage S66.

In practice, a voice message may have a maximum recording time (e.g., 30 seconds) and/or a text message may have a maximum number of characters (e.g., 150 characters) to minimize the memory capacity of watch 10.

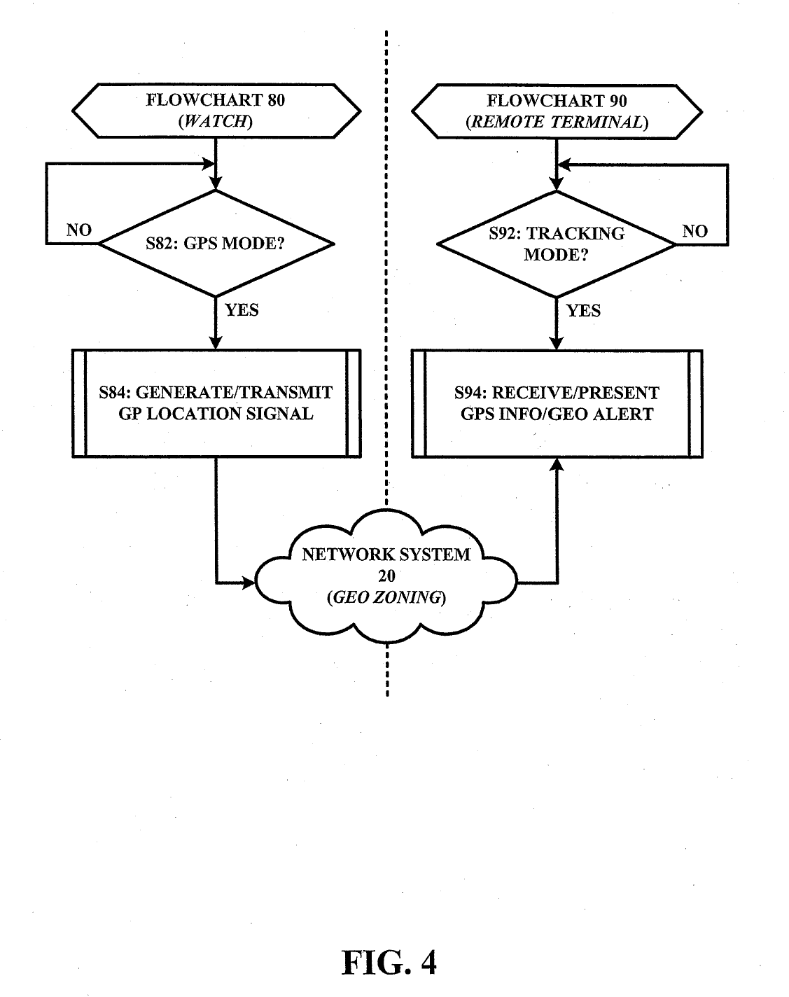

Referring again to FIG. 1, GPS/GEO module 15 is structurally configured for communicating information indicative of a location of watch 10 to one or more of the remote terminals 30-34. In one embodiment, GPS/GEO module 15 and the remote terminals 30-34 implement a GPS/GEO tracking method of the present invention as represented by respective flowcharts 80 and 90 illustrated in FIG. 4.

Referring to FIG. 4, upon watch 10 being activated into a GPS mode as determined during a stage S82 of flowchart 80, GPS/GEO module 15 executes a stage S84 of flowchart 80 to generate and transmit a GP location signal via network system 20 to the remote terminals 30-34 on a continual or intermittent basis. If the remote terminal(s) 30-34 is(are) activated in a tracking mode as determined during a stage S92 of flowchart 90, then the remote terminal(s) 30-34 will receive and present (i.e., display or audible) the GPS information during a stage S94 of flowchart 90. Additionally, stage S94 encompasses the remote terminal(s) 30-34 presenting a GEO alert as known in the art as an indication of watch 10 being outside of one or more zoned areas.

In practice, a high sensitive SIRF Star II. GPS receiver along with a laptop locator with worldwide mapping 3D software may be installed in the remote terminals 30-34, particularly laptop 33, to thereby facilitate a real-time operation tracking mode of locating watch 10 as would be appreciated by those having ordinary skill in the art.

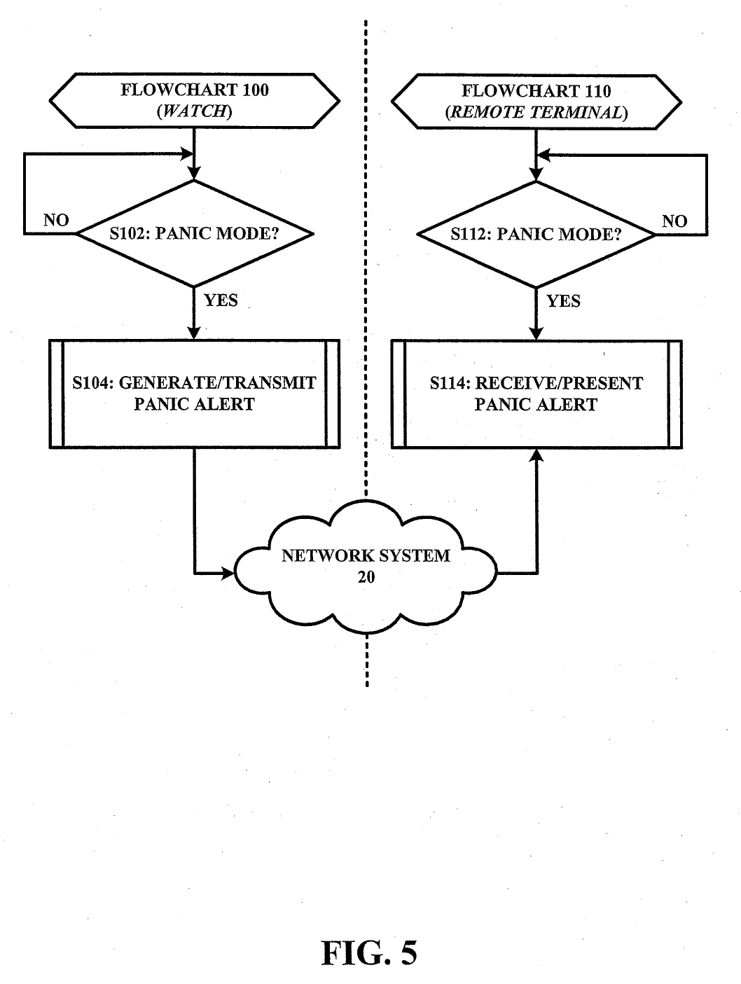

Referring again to FIG. 1, emergency module 16 is structurally configured for communicating an emergency alert signal from watch 10 to one or more of the remote terminals 30-34. In one embodiment, emergency module 16 and the remote terminals 30-34 implement an emergency notification method of the present invention as represented by respective flowcharts 100 and 110 illustrated in FIG. 5.

Referring to FIG. 5, upon watch 10 being activated into a panic mode as determined during a stage S102 of flowchart 100 (e.g., a user of watch 10 activates or presses a panic button), emergency module 16 executes a stage S104 of flowchart 100 to generate and transmit a panic alert via network system 20 to one or more of the remote terminals 30-34 on a continual or intermittent basis. If the remote terminal(s) 30-34 is(are) activated in a panic mode as determined during a stage S112 of flowchart 110, then the remote terminal(s) 30-34 will receive and present (i.e., display, or audible) the panic alert during a stage S114 of flowchart 110.

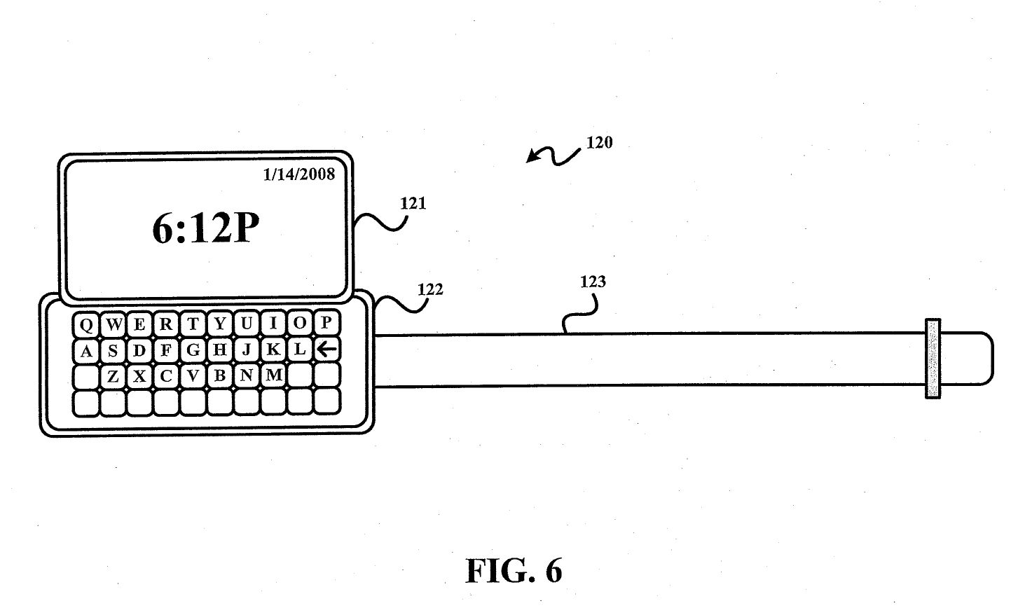

FIG. 6 illustrates an exemplary embodiment 120 of a timepiece of the present invention. As shown, watch 120 employs a digital watch 121, a keyboard 122, and a wrist strap 123. Installed within digital watch 121 are a digital version of time progression module 11 (FIG. 1), a Bluetooth™/WiFi enabled version of wireless communication module 12 (FIG. 1), and software/firmware versions of modules 13-16 (FIG. 1) in accordance with the various methods illustrated in FIGS. 2-5. Additionally, in practice, the screen of digital watch 121 may be a 4.0″ extra wide WQVGA screen with 64 colors and 120×360 pixels, various maps (e.g., the US, Canada and Europe) may be preloaded on a 20 MB flash disk in digital watch 121 and/or a remote terminal, a USB port may be used in digital watch 121 for updates and downloads, a 3-axis accelerometer & gyroscope may be used in digital watch 121 and/or a remote terminal for enhanced navigation, and digital watch 121 may have a 400 Mhz ARM920T processor and 64 MB or RAM with 16 GB free space for MP3 capability and photographs.

Referring to FIGS. 1-7, those having ordinary skill in the art of timepieces will appreciate numerous benefits of the present invention, including, but not limited to, the affordability of a timepiece of the present invention as compared to mobile/cellular phones offering equivalent services. Additionally, modules as described herein can be structurally configured in any form (e.g., software, hardware, and/or firmware) and installed in any manner within a timepiece of the present invention. As such, a timepiece of the present invention may include one or more processing/controller components for operating the modules.

Furthermore, those having ordinary skill in the art of timepieces may develop other embodiments of the present invention in view of the inventive principles of the present invention described herein. Thus, the terms and expression which have been employed in the foregoing specification are used herein as terms of description and not of limitations, and there is no intention in the use of such terms and expressions of excluding equivalents of the features shown and described or portions thereof, it being recognized that the scope of the present invention is defined and limited only by the claims which follow.

I claim:

1. A timepiece, comprising:
a watch; and
a biometric module installed into the watch, wherein the biometric module is operable to communicate any detected removal of the watch from a person wearing the watch to at least one remote terminal.

2. The timepiece of claim 1, further comprising:
a telecommunication module installed into the watch, wherein the telecommunication module is operable to communicate at least one of a voice message and a text message between the watch and the at least one remote terminal.

3. The timepiece of claim 1, further comprising:
a global positioning system module installed into the watch, wherein the global positioning module is operable to communicate information indicative of a location of the watch to the at least one remote terminal.

4. The timepiece of claim 3, wherein the global positioning system module and the remote terminal communicate through a network system in a real-time operation mode.

5. The timepiece of claim 1, further comprising:
an emergency module installed into the watch, wherein the emergency module is operable to communicate an emergency alert signal from the watch to the at least one remote terminal.

6. The timepiece of claim 1, wherein the at least one remote terminal includes at least one of a landline telephone, a cellular phone, a personal computer, a laptop and a personal data assistant.

7. The timepiece of claim 1, further comprising:
a keyboard operably coupled to the watch.

8. The timepiece of claim 1, further comprising:
a wrist strap operably coupled to the watch.

9. A timepiece, comprising:
a watch; and
means for communicating any detected removal of the watch from a person wearing the watch to at least one remote terminal.

10. The timepiece of claim 9, further comprising:
means for communicating at least one of a voice message and a text message between the watch and the at least one remote terminal.

11. The timepiece of claim 9, further comprising:
means for communicating information indicative of a location of the watch to the at least one remote terminal.

12. The timepiece of claim 11, wherein the timepiece and the remote terminal communicate through a network system in a real-time operation mode.

13. The timepiece of claim 9, further comprising:
means for communicating an emergency alert signal from the watch to the at least one remote terminal.

14. The timepiece of claim 9, wherein the at least one remote terminal includes at least one of a landline telephone, a cellular phone, a personal computer, a laptop and a personal data assistant.

15. The timepiece of claim 9, further comprising:
a keyboard operably coupled to the watch.

16. The timepiece of claim 9, further comprising:
a wrist strap operably coupled to the watch.
